(19) United States
(12) Patent Application Publication
(10) Pub. No.: US 2005/0202181 A1
(43) Pub. Date: Sep. 15, 2005

(54) Method for the spray application of plastic layers

(76) Inventors: Maik Grossmann, Adelheidsdorf (DE); Thomas Freser-Wolzenburg, Garbsen (DE); Georg-Wilhelm Prahst, Lauenau (DE); Carsten Kliwer, Braunschweig (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/498,469

(22) PCT Filed: Dec. 13, 2002
(86) PCT No.: PCT/EP02/14240

§ 371 Date: May 20, 2005

(30) Foreign Application Priority Data
Dec. 14, 2001 (DE) 101 61 600.7

(51) Int. Cl. B05D 7/00; B05C 5/00

(52) U.S. Cl. 427/421.1; 118/308; 118/313

(57) ABSTRACT

A method and a device for applying a filler-containing plastics layer to even a shaped surface, in which a mixture containing a binder or a binder mixture and a filler is sprayed onto the surface, a free jet for application by spraying first being generated from a binder or binder mixture and the filler then being added to the free jet of the not yet polymerized binder or binder mixture. The method is particularly suitable for the spray application of heavy layers such as those used in conventional mass-spring systems.

The invention relates to a method of applying a filler-containing plastics layer to a surface, in particular a shaped surface.

The invention relates, in particular, to a method of applying a heavy layer to a shaped surface to produce a sound-insulating multi-layer wall cladding, such as those used, for example, in vehicle interior claddings.

Sound-insulating multi-layer wall claddings that are applied to the vehicle interior in a contour-following way have already been known for a fairly long time. DE-OS 20 06 741 describes, for example, a multi-layer sound-insulating component that comprises a formed carpet and a correspondingly formed heavy layer that are joined together by a standard method, for example gluing, and that is mounted in a floating way on a layer of dynamically soft material on the bodywork of the vehicle. It is furthermore described that the carpet area must only be applied locally, preferably in the region of the splash wall, the wheel housings and in the legroom in front of the front seats. However, this lining still has a relatively high weight.

DE-PS 11 86 648 describes a sound-absorbing and vibration-damping material for metal cladding sheets for machines that comprises a layer of soft-elastic sound-absorbing foam material and a vibration-damping synthetic-resin layer joined to the layer. A mineral filler may be added to said synthetic-resin layer to form a heavy layer. To produce the sound-absorbing material, the vibration-damping material may be applied by spraying or in another way in the form of a mixture of binder and filler directly to the elastic foam-material layer or an interlayer of fabric.

DE 28 00 914 describes sound-insulating multi-layer wall claddings for the walls of vehicles or machines that comprises a heavy layer that is assigned to the wall to be clad and that is formed by a binder containing more than 40 wt. % filler and is arranged on a soft-elastic interlayer. Various conventional methods that have in common that a heavy insulating layer is produced from a mixture of plasticized binder, filler and, optionally, further additives with the aid of an extruder or calender are described for producing these multi-layer wall claddings. These are either made to solidify directly in the desired shape or they are first allowed to cure and are then brought to the desired shape by a suitable method, such as deep drawing or vacuum forming.

Disadvantages of the conventional injection-moulding methods are that the heavy layers have a relatively high weight and that the devices used to produce said layers wear rapidly and, in particular, the mixing heads have to be replaced frequently.

Proceeding from this state of the art, the object of the invention is to provide an improved method with which a plastics layer containing solid matter can be applied in a desired way, in particular, to a shaped surface and also a suitable device for performing the method.

This object is achieved by a method having the features according to claim 1. Advantageous refinements and developments of the invention and also a device for performing the method are the subject of subclaims 2 to 18.

The invention is based on the insight that a substantial weight saving occurs if the heavy layer is formed in such a way that it has the thickness and/or density necessary in each case to suit the local structural and acoustic conditions. As a result, the heavy layer can be formed with a lower thickness and/or density, for example, at points in the vehicle where only low sound insulation is necessary. On the other hand, regions having high sound transmission can be more strongly insulated and damped. In total, the invention consequently makes possible a better sound insulation since every region of the cladding can be individually designed to suit as well as possible the acoustic conditions that are determined, for example, on the basis of measurements.

The invention therefore provides an improved method with which such layers having, in particular, locally different density and/or thickness can be produced in a simple way.

The controllable and variable structure of the heavy layer is achieved, according to the invention, in that a filler-containing plastics layer is applied, in particular, to a shaped surface by spraying, a free jet for the spray application first being produced from a binder or binder mixture. The filler is added only subsequently to the free jet of the not yet polymerized binder or binder mixture.

The filler is added via one or more, preferably individually controllable solid-matter-spraying nozzle(s) and can thereby be accurately controlled and regulated as required. The metered addition of the filler can be adjusted variably by the method according to the invention even during the spraying operation.

The filler is preferably a high-density flowable solid and should be added in an amount of 10 to 90 wt.%, preferably 50 to 80 wt.%, based on the final mixture.

All the conventional binders suitable for producing mass-spring systems can be used in the standard mixing ratios as binders in the method according to the invention. Preferably, components should be used that fulfil the current requirements relating to recycling capability and can be recycled as far as possible without difficulty at the end of the product lifecycle. According to the invention, preferred binders are polyurethane-based binders, in particular those that can be produced on the basis of a polyol-isocyanate mixture. However, other suitable binders may also be used.

The local density and thickness of the layer applied by spraying can be variably controlled, according to the invention, even during the process by regulating or controlling the filler feed.

To perform the method according to the invention, the invention furthermore provides a device in accordance with claim 10. It was found that the erosion, that is to say the wear, of the device, in particular of the mixing head, is substantially reduced by the method according to the invention. This also reduces the drift in the mixing quality, which substantially influences the assurance of a constant product quality.

The invention relates to a device for the application of a plastics layer containing solid matter to a surface by spraying using a mixing head that has a first means for generating a free jet of the binder mixture and at least one second means for the metered feed of a filler, characterized in that the second means for the metered feed of the filler is disposed in such a way that the filler is added to the binder mixture in the free jet emerging from the mixing head.

In the device, a plurality of second means may be provided for the metered feed of the filler, which means are disposed in a rotationally symmetrical way with respect to the first means. Preferably, the device has three second means that are disposed at an angular separation of about 120° around the first means.

The second means preferably comprise solid-matter-spraying nozzles that can be individually controlled independently or in a coupled way. In accordance with a preferred embodiment, they furthermore comprise a particularly wear-resistant material, for example a ceramic material.

The invention furthermore relates to plastics layers that are produced by the method according to the invention or by means of the device according to the invention. These may have partly or locally varying densities and/or thicknesses. A further embodiment relates to single-layer or multi-layer two-component polyurethane systems, sound-insulating or sound-damping components and also heavy layers for sound-insulating mass-spring systems comprising one or more layers that are produced by the method according to the invention.

The invention is explained below by reference to the exemplary embodiments shown in the drawings. In the drawings:

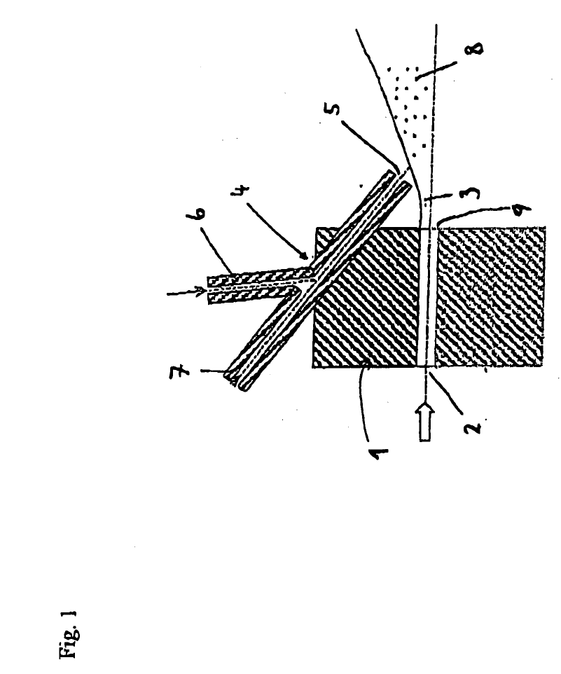

FIG. 1 shows a diagram explaining a device according to the invention for applying a plastics layer, in particular, to a shaped surface;

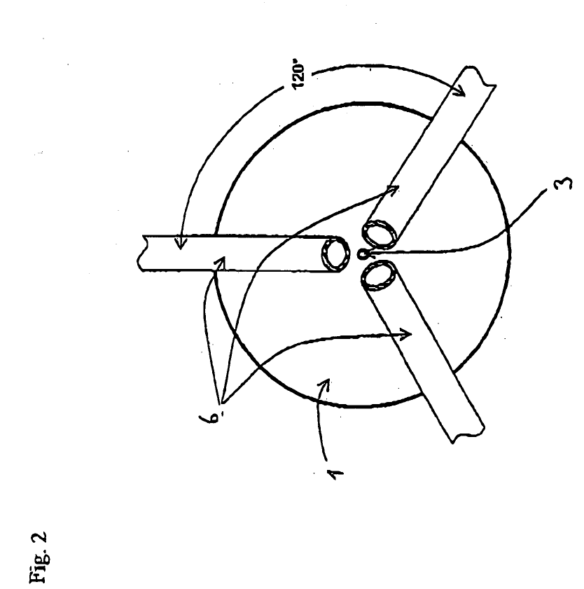

FIG. 2 shows a diagram explaining the filler feed using the example of an embodiment comprising three symmetrically disposed filler nozzles;

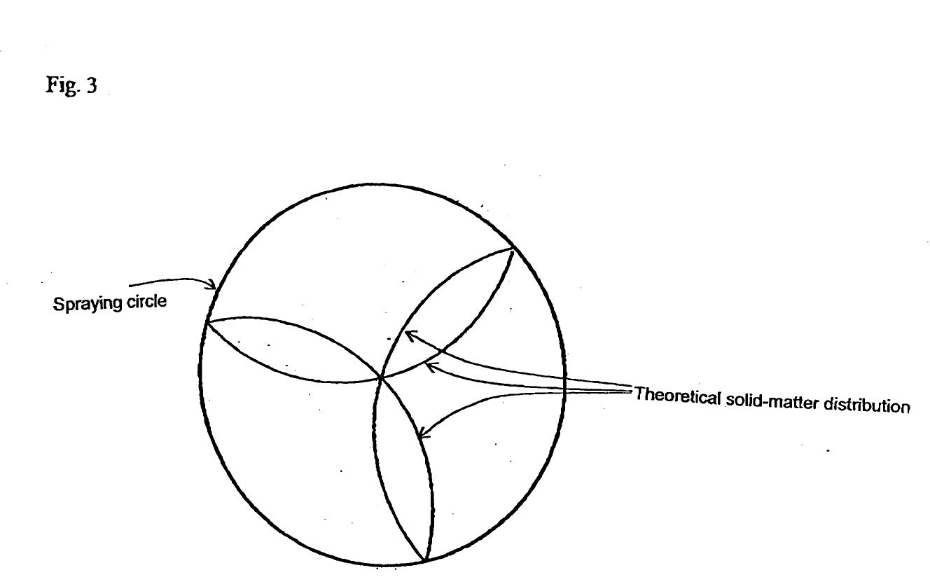

FIG. 3 shows a diagram explaining the filler distribution on the surface to be sprayed with an arrangement of the solid-matter-spraying nozzles as in FIG. 2.

In the method according to the invention, filler-containing plastics layers are applied, in particular, to a shaped surface by spraying. The method is suitable, in particular, for producing heavy layers for sound-insulating or sound-damping components that operate according to the known mass-spring system. The method according to the invention forms heavy layers by spray application directly to the foam layer or spring layer or, optionally, a further interlayer.

The foam layer or spring layer in standard mass-spring systems is composed of an open-cell or closed-cell foam, of an impregnated fibre material of organic, natural or synthetic fibres or even of inorganic, natural or synthetic fibres. The filler-containing plastics layer can be applied to surfaces of any shape by the spraying method.

The method will now be explained in detail by reference to the exemplary embodiment in FIG. 1.

In the method according to the invention, a free jet is first generated from a binder or a binder mixture with the aid of a mixing head having nozzles. The nozzle diameter should be 0.1-5 mm, preferably 0.5-3 mm.

Thermoplastics, for example polyvinyl acetate, polyvinyl propionate, polyacrylates, polymethacrylates, polystyrene, polyethylene as homopolymers or copolymers or mixtures thereof, two-component synthetic resins, for example polyurethane, epoxy resin, polyesters and the like, bitumen, pitch, wax, tree or root resins, natural and synthetic rubber, regenerated rubber or mixtures thereof may be used as binders. Preferred binders are two-component synthetic resins, in particular polyurethane-based binders.

Polyol/isocyanate mixtures having a pressure range of 20-250 bar, preferably 60-150 bar, and a polyol temperature range of 10-150° C., preferably 20-100° C., and an isocyanate temperature range of 10-100° C., preferably 20-60° C. are found to be beneficial, in particular, for sound-engineering applications. The polyol/isocyanate mixing ratio is 100/5 to 100/90, preferably 100/8 to 100/80.

After the free jet 3 emerges from the mixing head 1, a filler is added outside the mixing head 1 to the not yet polymerized binder mixture approximately in one region. The filler is fed with the aid of a standard filler conveyor that is capable of conveying a flowable filler in a thick stream.

The filler is preferably a flowable high-density solid. The density of suitable fillers according to the invention is in the region above 2 g/cm³, preferably above 4.5 /cm³. The amount of filler or solid added depends, in particular, on the binder used and the required density of the layer to be applied. The mixing ratio of binder to filler can be determined in a simple way for the person skilled in the art, for example by trials in which the spraying distance, i.e. the distance between the mixing head and the surface to be coated should be 20-500 mm, preferably 100-250 mm in order to ensure a uniform blending in the spraying jet 8. The filler should preferably be added in a filler loading amount of 10 to 90 wt. %, preferably 50 to 80 wt. %, based on the final mixture.

The filler may consist of one or more particulate materials that have at least one, preferably a plurality of the following properties: it should have a specific weight of more than 2 g/cm³, be finely ground, have a bulk density of more than 600 g/l and have a particle size (particle diameter) of between 10 and 500 mm, preferably between 50 and 250 mm. The fillers used according to the invention should be readily pourable. Preferred fillers are granular, platelet-like or powder-like particles, for example of barium sulfate (BaSO₄).

The filler is added from one or more directions via one or more solid-matter-spraying nozzles 5, in particular up to 16, preferably 2 to 6 solid-matter-spraying nozzles that are disposed symmetrically at the mixing head 1. Particularly preferably, the filler is fed via three solid-matter-spraying nozzles that are disposed at an angular separation of about 120°. This achieves an optimum blending and compounding of binder and filler in the spraying jet, with the result that a uniform distribution of the filler and, consequently, a uniform density distribution are also achieved in the final product. The diameter of the solid-matter-spraying nozzles 5 should be 0.1-10 mm, preferably 1-5 mm.

The metered addition of the filler can be variably controlled by the method according to the invention, in particular even during the spraying operation. The filler content in the spraying jet 8 may be freely chosen and continuously re-adjusted and altered in accordance with the requirements of the surface regions to be coated. The density of the layer applied by spraying can be determined by controlling the filler content in the spraying jet 8.

The filler is expediently fed into the spraying jet by means of compressed air or another pressurized fluid that, preferably, does not react with the materials involved. Furthermore, the negative pressure gradient in the direction of or into the free jet 3 is utilized in the method according to the invention. The binder, which emerges from the mixing head 1 in the form of a free jet 3, entrains the added filler as it emerges from the filler nozzle 5 in the streamline, thereby producing a homogeneous spraying jet 8.

Further advantageous effects that are achieved by the method according to the invention are that an optimum mixing and compounding of binder and filler is produced in the spraying jet 8, which results in a uniform filler distribution and, consequently, density distribution in the finished product. In this way, products having very high densities can also be produced.

In addition to the negative pressure gradient, the method according to the invention is promoted by the wave disintegration and atomization of the filler in the free jet 3. When the filler is added to the free jet 3, it is absorbed and uniformly blended therein by the internal turbulence of the liquid of the jet.

Furthermore, the risk of overspray and jet disintegration is reduced in that the speed of the binder free jet 3 can be reduced due to conservation of momentum and the high specific weight of the filler. This makes it possible to increase the application precision of the binder or the binder mixture and the added filler.

Finally, the method contributes to the fact that the spraying device used is subjected to lower wear since the particulate filler, which causes abrasion, does not get either into the mixing head 1 or into tubes connected thereto. On the one hand, this prolongs the service life of the tools, which substantially saves costs, and on the other hand, the product quality is maintained over a longer period of time. In conventional methods, on the other hand, a drift that is presumably attributable to erosion of the mixing head is observed in the mixing quality after a certain operating time.

The method can also be modified or extended in a way known to the person skilled in the art. Thus, for example, in addition to the components mentioned, further auxiliary substances or additives that are known in the prior art can be added to the binder mixture.

Furthermore, the invention provides a device for the application of a plastics layer containing solid matter, in particular, to a shaped surface by spraying, with which device the above-mentioned method can be performed. The device, which is described on the basis of FIG. 1, comprises a mixing head 1, the one first means 2 for generating a free jet 3 of the binder or the binder mixture and at least one second means 4 for the metered feed of a filler. The first means 2 preferably has a nozzle 5 for feeding or ejecting the binder mixture.

In this connection, the filler feed can be metered and controlled via a feedline 6 in a way known per se by means of compressed air that is applied via a further feedline 7 and entrains the added filler in the free jet 3. The metered addition of the filler is further promoted by the negative pressure gradient described above.

The second means 4 for the metered feed of filler 5 is arranged, according to the invention, in such a way that the filler is added to the binder mixture in the free jet 3 emerging from the mixing head 1. For the purpose of uniform filler feed, the device preferably has at least two, more preferably three, second means 4 for the metered feed of the filler. These should be disposed in a rotationally symmetrical manner with respect to the first means 2.

A particularly preferred embodiment is shown in FIG. 2, in which three second means 4 are distributed around the first means 2 at an angular spacing of about 120°. This arrangement makes it possible to achieve the best possible filler distribution in the spraying jet 8. The filler distribution theoretically achievable with this preferred device in the spraying circle is shown in FIG. 3.

The second means 4 should be arranged in such a way that the filler is added to the free jet 3 as directly as possible at only a short distance after the emergence of the free jet 3 from the first means 2. With increasing distance, the scattering of the spraying jet 8 increases. This results in a poorer blending and a more inexact application precision of the filler-containing plastics mixture formed in the spraying jet 8.

The second means 4 preferably have solid-matter-spraying nozzles 5 that can be controlled individually in an independent or coupled way. The independent control capability is advantageous, in particular, in the case of applications in which the spraying angle is not perpendicular to the application surface. In particular, in the case of severely shaped surfaces or surfaces having fairly large elevations and depressions, the spraying jet 8 frequently strikes the surface at an acute or obtuse angle. In such cases, a partial separation of the spraying jet 8 and, consequently, a non-uniform distribution of the filler in the product could easily result because of the high difference in density between binder or binder mixture and filler. The individual solid-matter-spraying nozzles 5 can be controlled separately by the method according to the invention, with the result that the filler feed can be independently adjusted and regulated via the respective nozzles 5. As a result, a uniform application can be ensured even with extreme spraying angles.

To reduce the erosion due to the filler particles, the means 4 can be produced from a resistant material, for example from a ceramic material, completely or at least in the region of the filler nozzles 5.

Finally, the invention relates to the products produced by the method according to the invention or the device according to the invention. The method is suitable for producing numerous plastics layers, in particular those that have partly varying densities and/or thicknesses. The method is particularly suitable for producing two-component polyurethane systems comprising one or more layers, sound-insulating or sound-damping components comprising one or more layers and heavy layers for sound-insulating mass-spring systems, such as those used in the automobile industry for sound insulation.

The products produced according to the invention are notable for a particularly uniform filler distribution in the respective regions that may be of varying thickness and/or densities.

1. Method of applying a filler-containing plastic layer to even a shaped surface, wherein a mixture containing a an unpolymerized binder or an unpolymerized binder mixture and a filler is sprayed onto the surface, comprising
a) generating a free jet for application by spraying the unpolymerized binder or the unpolymerizing binder mixture, and
b) adding the filler to the free jet of the unpolymerized binder or unpolymerized binder mixture.

2. Method according to claim 1, comprising adding the filler via at least one individually controllable solid-matter-spraying nozzle.

3. Method according to claim 1, comprising variably adjusting the metered addition of the filler during the process.

4. Method according to claim 1, wherein the added filler is a flowable high-density solid.

5. Method according to claim 4, wherein the density of the solid is above 2 g/cm³.

6. Method according to claim 1, comprising adding the filler in an amount of 10 to 90 wt. %, based on the final mixture.

7. Method according to claim 1, comprising adding the filler in an amount of 50 to 80 wt. %, based on the final mixture.

8. Method according to claim 1, wherein the binder is a polyurethane-based binder.

9. Method according to claim 1, comprising variably controlling the densities and/or thicknesses of the layer applied by spraying during the process.

10. Device for applying a plastics layer containing solid matter, comprising a mixing head a generator for generating a free jet of a binder or a binder mixture and at least one feeder for the metered feed of a filler, wherein the feeder is disposed in such a way that the filler is added to the free Jet emerging from the mixing head.

11. Device according to claim 10, comprising a plurality of feeder for the metered feed of the filler arranged in a rotationally symmetrical way with respect to the generator.

12. Device according to claim 10, comprising three feeders disposed around the generator at an angular separation of about 120°.

13. Device according to claim 10, wherein generator has solid-matter-spraying nozzles that are individually controllable in an independent or coupled way.

14. Device according to claim 10, wherein at least the solid-matter-spraying nozzles of the feeder comprise ceramic material.

15-18. (canceled)

19. Method according to claim 4, wherein the density of the solid is above 4.5 /cm³.
